(19) United States
(12) Patent Application Publication
(10) Pub. No.: US 2015/0261811 A1
(43) Pub. Date: Sep. 17, 2015

(54) METHODS AND SYSTEMS FOR DETECTING DATA CONTAINER MODIFICATION

(71) Applicant: NETAPP, INC., Sunnyvale, CA (US)

(72) Inventor: Mark Muhlestein, Sunnyvale, CA (US)

(73) Assignee: NETAPP, INC., Sunnyvale, CA (US)

(21) Appl. No.: 14/212,752

(22) Filed: Mar. 14, 2014

(51) Int. Cl. G06F 17/30

(52) U.S. Cl. CPC G06F 17/30386

(57) ABSTRACT

Methods and system for determining if a data container has been modified are provided. A first data container signature and a second data signature are generated by a storage operating system based on metadata information for the data container. The second data container signature is compared with the first data container signature to determine if the data container has been modified since the first data container signature was generated.

### BACKGROUND

1. Technical Field

The present disclosure relates to storage systems in general and in particular, to efficiently detecting data container modification.

2. Related Art

A storage system typically comprises one or more storage devices where data containers (for example, files, directories, structured or unstructured data) may be stored. The storage system typically includes a processor executable storage operating system that functionally organizes the system by, inter alia, invoking storage operations (i.e. reading and writing data containers) in support of a storage service implemented by the storage system. The storage system may be implemented in accordance with a variety of storage architectures including, but not limited to, a network-attached storage environment, a storage area network and a storage device directly attached to a user or host computer.

Storage systems typically store a large number of data containers for numerous client machines. Applications that use the storage systems may want to know if data container content has been modified. This can be challenging, especially when storage systems typically store thousands or millions of data containers in a networked computing environment.

Conventional systems may generate hash values based on data container content to determine if a particular data container has been modified. When the data container is modified, the hash values based on data container content are different and hence one is able to detect data container modification by comparing content based hash values. This approach however is undesirable because generating hash values for thousands or millions of data containers based on data container content consumes a large amount of computing resources. Continuous efforts are being made to efficiently detect data container modification.

### SUMMARY

In one aspect, a machine implemented method is provided. The method includes generating a first data container signature and a second data container signature by a storage operating system based on metadata information of the data container; and comparing the second data container signature with the first data container signature to determine if the data container has been modified since the first data container signature was generated.

In another aspect, a non-transitory, machine readable storage medium storing executable instructions, which when executed by a machine, causes the machine to perform a method, is provided. The method includes generating a first data container signature and a second data container signature by a storage operating system based on metadata information of the data container; and comparing the second data container signature with the first data container signature to determine if the data container has been modified since the first data container signature was generated.

In another aspect, a system having a processor executing instructions out of a memory is provided. The processor executes instructions to generate a first data container signature and a second data container signature based on metadata information for the data container. The second data container signature is compared with the first data container signature to determine if the data container has been modified since the first data container signature was generated.

This brief summary has been provided so that the nature of this disclosure may be understood quickly. A more complete understanding of the disclosure can be obtained by reference to the following detailed description of the various embodiments thereof in connection with the attached drawings.

### BRIEF DESCRIPTION OF THE DRAWINGS

The foregoing features and other features will now be described with reference to the drawings of the various aspects. In the drawings, the same components have the same reference numerals. The illustrated aspects are intended to illustrate, but not to limit the present disclosure. The drawings include the following Figures:

FIG. 1 shows a block diagram of a network storage system using the methodology of the present disclosure;

FIG. 2 shows an example of an operating system used by a storage system of FIG. 1, according to one aspect of the present disclosure;

FIG. 3A shows a block diagram on an inode structure used by a storage operating system for storing metadata information about data containers, according to one aspect of the present disclosure;

FIG. 3B shows a process flow according to one aspect of the present disclosure;

FIG. 4 shows a hierarchical inode structure storing metadata information that is used according to one aspect of the present disclosure; and

FIG. 5 shows a block diagram of a computing system, used according to one aspect of the present disclosure.

### DETAILED DESCRIPTION

As a preliminary note, the terms “component” “module”, “system,” and the like as used in this disclosure are intended to refer to a computer-related entity, either software, hardware, a combination of hardware and software, or software in execution. For example, a component may be, but is not limited to being, a process running on a hardware based processor, a hardware based processor, an object, an executable, a thread of execution, a program, and/or a computer.

By way of illustration, both an application running on a server and the server can be a component. One or more components may reside within a process and/or thread of execution and a component may be localized on one computer and/or distributed between two or more computers. Also, these components can execute from various non-transitory computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other device, in accordance with the claimed subject matter.

In one aspect, methods and systems for determining if a data container has been modified are provided. A first data container signature and a second data signature are generated by a storage operating system based on metadata information for the data container. The second data container signature is compared with the first data container signature to determine if the data container has been modified since the first data container signature was generated.

To facilitate an understanding of the various aspects of the present disclosure, the general architecture and operation of a networked storage system will first be described. The specific architecture and operation of the various aspects will then be described with reference to the general architecture.

System 100:

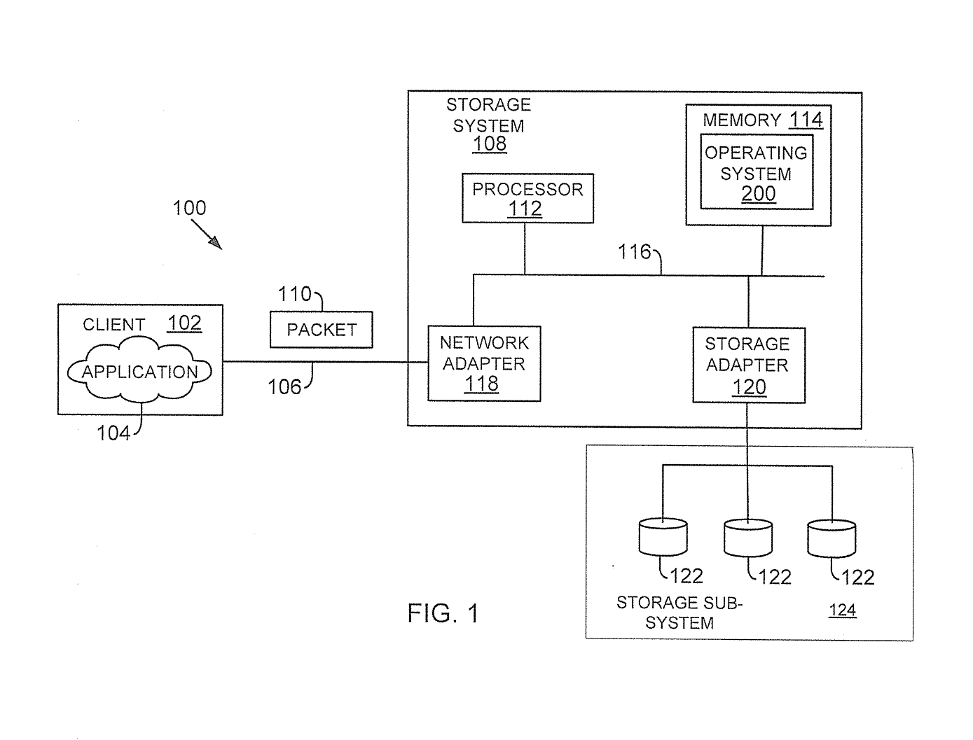

FIG. 1 is a schematic block diagram of an operating environment 100 (may also be referred to as system 100) having a storage system 108 (may also be referred to as storage server) that may be advantageously used with the present disclosure. Storage system 108 is used to store one or more data containers, for example, directories, files, structured and unstructured data. It is noteworthy that the term data container as used throughout this specification includes a file, a directory, or structured and unstructured data.

The storage system 108 may be one or more computing system that provides storage services relating to organization of information at mass storage devices, such as storage devices 122 of a storage sub-system 124. Storage devices 122 may be, for example, tape drives, conventional magnetic disks, optical disks such as CD-ROM or DVD based storage, magneto-optical (MO) storage, flash memory storage device or any other type of storage device suitable for storing structured and unstructured data. Some of the examples disclosed herein may reference a storage device as a “disk” or a “disk drive” but the adaptive aspects disclosed herein are not limited to any particular type of storage media/device.

The storage system 108 comprises one or more processor 112 (also referred to as a central processing unit), a memory 114, a network adapter 118 and a storage adapter 120 interconnected by an interconnect system (also referred to as a “bus system”) 116. In the illustrative aspect, memory 114 comprises storage locations that are addressable by processor 112 and other modules, for example, storage adapter 120 and network adapter 118 for storing machine executable instructions.

Processor 112 may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware based devices.

The bus system 116, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

The network adapter 118 includes mechanical, electrical and signaling circuitry needed to connect the storage system 108 to one or more client systems 102 (shown as client 102) over a connection system 106 (also referred to as network 106), which may comprise a point-to-point connection or a shared medium, such as a local area network. Illustratively, connection system 106 may be embodied as an Ethernet network, a Fibre Channel (FC) network or any other network type. The client 102 may communicate with the storage system 108 via network 106 by exchanging discrete frames or packets 110 of data according to pre-defined protocols, such as the Transmission Control Protocol/Internet Protocol (TCP/IP) or any other protocol type.

Client 102 may be a general-purpose computer configured to execute processor executable applications 104. Moreover, client 102 may interact with the storage system 108 in accordance with a client/server model of information delivery. That is, the client may request the services of the storage system, and the system may return the results of the services requested by the client, by exchanging packets 110 over the network 106. The clients may issue packets using file-based access protocols, such as the Common Internet File System (CIFS) protocol or Network File System (NFS) protocol, over TCP/IP when accessing information in the form of files and directories. Alternatively, the client may issue packets using block-based access protocols, such as the Small Computer Systems Interface (SCSI) protocol encapsulated over TCP (iSCSI) and SCSI encapsulated over Fibre Channel Protocol (FOP), when accessing information in the form of blocks.

The storage adapter 120 cooperates with a storage operating system 200 executed by processor 112 to access information requested by a user (or client). The storage adapter 120 includes input/output (I/O) interface circuitry that couples to the storage devices over an I/O interconnect arrangement, such as a conventional high-performance, Fibre Channel serial link topology.

The storage operating system 200 preferably implements a high-level module, such as a file system, to logically organize information as a hierarchical structure of data containers at storage devices 122. Storage operating system 200, portions of which are typically resident in memory 114 and executed by the processing elements, functionally organizes the system 108 by, inter alia, invoking storage operations executed by the storage system.

Storage operating system 200 presents storage volumes to clients 102 for reading and writing data. The term storage volume or volume as used herein means a logical data set which is an abstraction of physical storage, combining one or more physical mass storage devices or parts thereof into a single logical storage object. However, each storage volume can represent the storage space in one storage device, an aggregate of some or all of the storage space in multiple storage devices, a RAID (Redundant Array of Inexpensive Disks)group, or any other set of storage space.

A storage volume is typically a collection of physical storage devices 122 cooperating to define an overall logical arrangement of virtual volume block number (VVBN) space on the volume(s). Each logical volume is generally, although not necessarily, associated with its own file system. The storage devices within a logical volume/file system are typically organized as one or more groups, wherein each group may be operated as a RAID.

To facilitate access to storage devices 122, in one aspect, the storage operating system 200 may implement a Write Anywhere File Layout (WAFL™) file system (without derogation of any trademark rights of NetApp Inc. in NetApp®, ONTAP™, WAFL™ and other terms used herein). The WAFL system logically organizes information as a hierarchical structure of named data containers, e.g. directories and files. Each “on-disk” data container may be implemented as set of blocks configured to store information, such as data, whereas the directory may be implemented as a specially formatted data container in which names and links to other data containers and directories are stored.

WAFL manages an aggregate that may include one or more storage volumes and physical storage. An aggregate is a physical storage container that can store data in the WAFL file system. Multiple, independently managed volumes can share the same physical storage (e.g., physical storage). The virtualization requires mapping between virtual volume block numbers (VVBNs) used for the volumes and physical volume block numbers (PVBNs) used by an aggregate to access data stored at physical storage 122. A PVBN, as used herein, refers to storage device blocks that have been abstracted into a single linear sequence in the aggregate.

In the illustrative aspect, the storage operating system 200 is preferably the NetApp® Data ONTAP™ operating system available from NetApp, Inc., Sunnyvale, Calif. that implements WAFL. However, it is expressly contemplated that any appropriate storage operating system may be enhanced for use in accordance with the inventive principles described herein. As such, where the term “WAFL” is employed, it should be taken broadly to refer to any storage operating system that is otherwise adaptable to the teachings of this disclosure.

Although storage system 108 is shown as a stand-alone system, i.e. a non-cluster based system, in another aspect, storage system 108 may have a distributed architecture that may include, for example, a separate N-(“network”) blade and D-(disk) blade. Briefly, the N-blade is used to communicate with client 102, while the D-blade is used to communicate with the storage devices 122 that are a part of the storage sub-system 124. The N-blade and D-blade may communicate with each other using an internal protocol. The term blade as used herein means a computing system, a processor based system, a module or any other similar system.

Alternatively, storage system 108 may have an integrated architecture, where the network and data components are all contained in a single enclosure. The storage system 108 further may be coupled through a switching fabric to other similar storage systems (not shown) which have their own local storage subsystems. In this way, all of the storage subsystems can form a single storage pool, to which any client of any of the storage servers has access.

Storage Operating System 200:

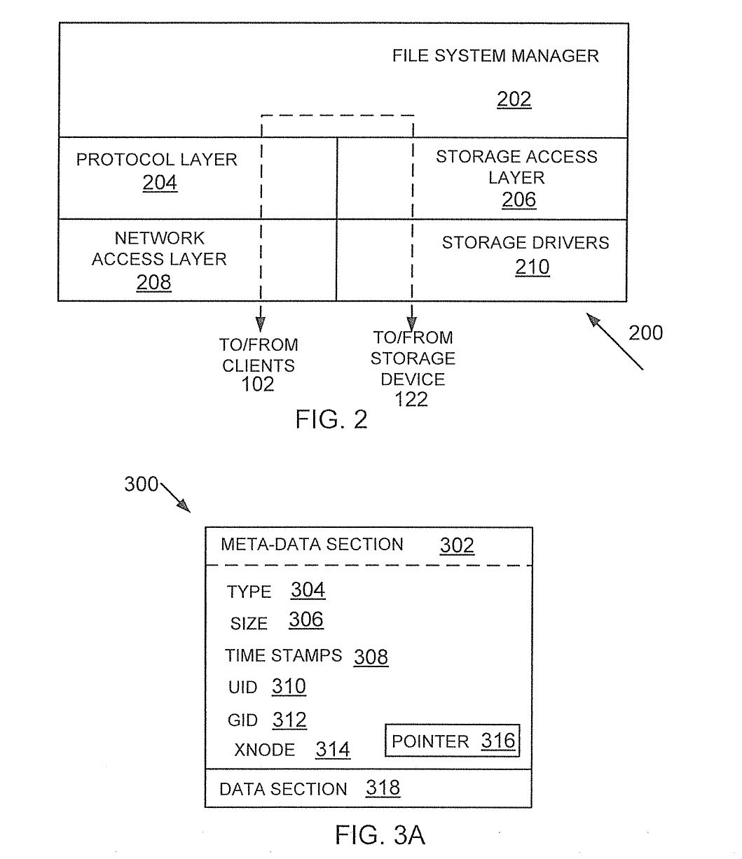

FIG. 2 illustrates a generic example of storage operating system 200 for storage system 108, according to one aspect of the present disclosure. In one example, storage operating system 200 may be installed at storage system 108. It is noteworthy that storage operating system 200 may be used in any desired environment and incorporates any one or more of the features described herein.

In one example, storage operating system 200 may include several modules, or hardware based, processor executable “layers”. These layers include a file system manager 202 that keeps track of a directory structure (hierarchy) of the data stored in storage subsystem 124 and manages read/write operations, i.e. executes read/write operations at storage devices 122 in response to client 102 requests. File system manager 202 may also provide data container signatures that are based on data container metadata/attributes, as described below. The signatures can be used by application 104 to determine if a data container has been modified. The details of determining data container modification are provided below.

Storage operating system 200 may also include a protocol layer 204 and an associated network access layer 208, to allow storage system 108 to communicate over a network with other systems, such as clients 102. Protocol layer 204 may implement one or more of various higher-level network protocols, such as NFS, CIFS, Hypertext Transfer Protocol (HTTP), TCP/IP and others.

Network access layer 208 may include one or more drivers, which implement one or more lower-level protocols to communicate over the network, such as Ethernet or any other protocol type. Interactions between clients 102 and mass storage devices 122 are illustrated schematically as a path, which illustrates the flow of data through storage operating system 200.

The storage operating system 200 may also include a storage access layer 206 and an associated storage driver layer 210 to allow storage system 108 to communicate with storage subsystem 124. The storage access layer 206 may implement a higher-level disk storage protocol, such as RAID, while the storage driver layer 210 may implement a lower-level storage device access protocol, such as FCP or SCSI. In one aspect, the storage access layer 206 may implement a RAID protocol, such as RAID-4.

It should be noted that the software “path” through the operating system layers described above needed to perform data storage access for the client request received at the storage system may alternatively be implemented in hardware. That is, in an alternate aspect of the invention, the storage access request data path may be implemented as logic circuitry embodied within a field programmable gate array (FPGA) or an application specific integrated circuit (ASIC). This type of hardware implementation increases the performance of the file service provided by storage system 108 in response to a file system request packet 110 issued by client 102. Moreover, in another alternate aspect of the invention, the processing elements of network and storage adapters (118, 120) may be configured to offload some or all of the packet processing and storage access operations, respectively, from processor 112 to thereby increase the performance of the file service provided by the storage system.

In one aspect, file system manager 202 includes a WAFL layer. As mentioned above, the WAFL based file system is block-based, i.e. stores information at storage devices as blocks, for example, using, e.g., 4 kilobyte (KB) data blocks, and using inodes to describe the files. An inode is a data structure, e.g., a 128-byte structure, which may be used to store information, such as meta-data, about a data container (for example, a file). The meta-data may include data information, e.g., ownership of the file, access permission for the file, size of the file, file type and location of the file at storage device, as described below. The WAFL layer uses a file handle, i.e., an identifier that includes an inode number and/or an inode generation number generated by the file system manager 202, to retrieve an inode from a storage device (122). The WAFL layer also uses files to store meta-data describing the layout of its file system. These meta-data files include, among others, an inode file.

Inode Structure:

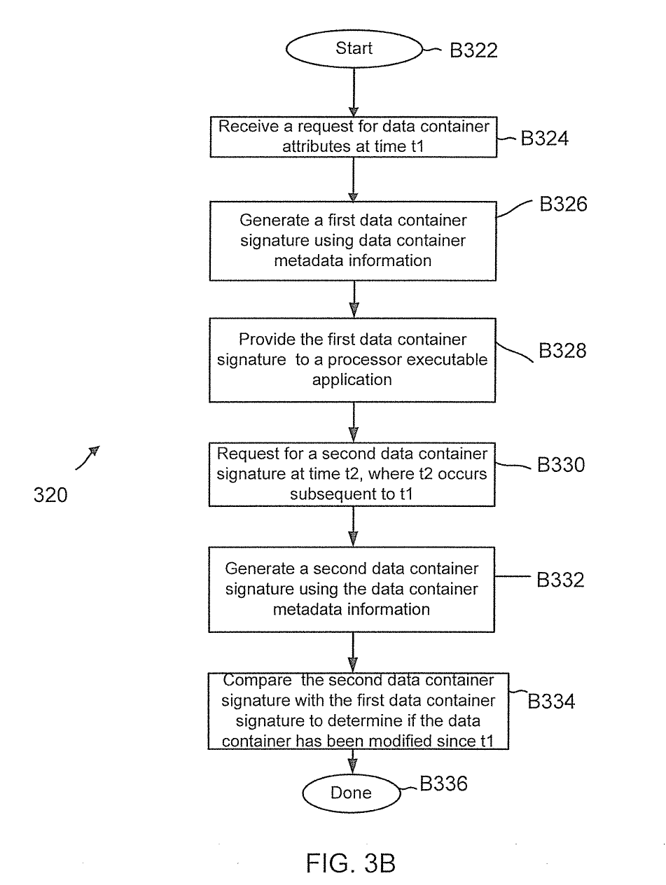

FIG. 3 shows an example of an inode structure 300 (may also be referred to as inode 300) used according to one aspect. Inode 300 may include a meta-data section 302 and a data section 318. The information stored in meta-data section 302 of each inode 300 describes a file and, as such, may include the file type (e.g., regular or directory) 304, size 306 of the file, time stamps 308 for the file and ownership, i.e., user identifier (UID 310) and group ID (GID 312), of the file. The metadata section 302 further includes an Xnode field 314 with a pointer 316 that references another on-disk inode structure having e.g., access control list (ACL) information (or ACL entries) associated with the file or directory. ACL entries are used to allow or deny access to user to any stored data container.

The contents of data section 318 of each inode 300 may be interpreted differently depending upon the type of file (inode) defined within the type field 304. For example, the data section 318 of a directory inode structure includes meta-data controlled by the file system, whereas the data section of a “regular inode” structure includes user-defined data. In this latter case, the data section 318 includes a representation of the data associated with the file.

Specifically, data section 318 of a regular on-disk inode file may include user data or pointers, the latter referencing, for example, 4 KB data blocks for storing user data at a storage device. Each pointer is preferably a logical volume block number to facilitate efficiency among file system manager 202.

Inode structure 300 may have a restricted size (for example, 128 bytes). Therefore, user data having a size that is less than or equal to 64 bytes may be represented, in its entirety, within the data section of an inode. However, if the user data is greater than 64 bytes but less than or equal to, for example, 64 kilobytes (KB), then the data section of the inode comprises up to 16 pointers, each of which references a 4 KB block of data stored at a storage device. Moreover, if the size of the data is greater than 64 kilobytes but less than or equal to 64 megabytes (MB), then each pointer in the data section 318 of the inode references an indirect inode that contains 1024 pointers, each of which references a 4 KB data block at storage device.

In one aspect, since file system manager 202 stores metadata for each container, the file system manager 202 is configured to produce a data container signature (or hash signature) for certain metadata fields of an inode, for example, file size, inode generation number, VVBNs, timestamp and others.

When a data container is modified, the file system manager 202 allocates a new block, which results in a modification of the highest block number that is stored within the inode structure 300. The hash signature may be configured to include the inode block numbers and other attributes (e.g. file size, inode generation number, time stamp and others). Thus anytime a data container is modified, the data container signature with the inode block number and the attributes would be different vis-à-vis the data container signature having the inode block number and attributes for the unmodified data container.

FIG. 3B shows a process 320 for determining data container modification, according to one aspect. The process begins in block B322, when a storage volume has been presented to a client (or application 104). Application 104 uses the storage volume to store data containers. The storage operating system 200 manages the underlying logical storage space for storing data at the physical storage devices 122.

In block B324, application 104 may send a request to storage operating system 200 to obtain a data container signature with data container attributes at time t1 for a data container. The file system manager 202 that maintains inodes and data container metadata generates a first data container signature using inode metadata information (for example, file size, time stamp, inode generation number and others) and/or VVBNs for the data container. File system manager 202 maintains the inodes and hence has access to the data container attribute information.

The first data container signature may be generated using different techniques, for example, the MD5, SHA-256 and other techniques. MD5 is a message-digest process that is used to produce a 128-bit (16-byte) hash value, typically expressed in text format as a 32 digit-hexadecimal number. SHA (Secure Hash Algorithm)-256 is another technique for generating hash functions. The various aspects described herein are not limited to any specific hash function technique.

In block B328, the storage operating system 200 provides the first data container signature to application 104.

In block B330, application 104 again requests a second data container signature at time t2, where t2 occurs after t1.

In block B332, the file system manager 202 generates the second data container signature using the metadata information. If the data container was modified, then file system manager 202 would have assigned a new block for the modified information. The new block would have a new VVBN value and the data container attribute would have changed compared to time t1.

In block B334, the second data container signature is compared with the first data container signature to determine if there has been any modification since time t1. Application 104 executed by a processor out of a memory device may perform the comparison. In another aspect, the file system manager 202 may perform the comparison. In that aspect, the file system manager 202 notifies the application 104 if the data container has been modified.

Based on the comparison, the application (or file system manager) determine if the data container has been modified. The process then ends at block B338.

Process 320 has various advantages over conventional techniques. Instead of using the entire data container content for data container signatures only metadata information is used for generating the signatures. This takes less processing time than the signatures generated using the entire data container content.

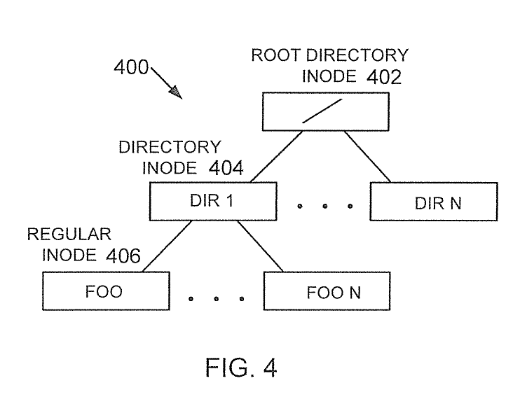

FIG. 4 is a schematic block diagram illustrating a hierarchical on-disk inode structure 400 used by file system manager 202. The inode structure 400 includes a root directory inode 402 having a plurality of directory inodes 404. Each directory inode 404 may include regular inodes 406.

For managing data container storage, the file system manager 202 parses the first (/) preceding a data container pathname and maps it to the root inode structure 402 of its file system. The root inode 402 is a directory with a plurality of entries, each of which stores a name of a directory and its corresponding mapping file handle. The file system manager 202 can convert that handle to a storage device block and, thus, retrieve a block (inode) from storage device.

Broadly stated, a file name is an external representation of an inode data structure, i.e., a representation of the inode as viewed external to the file system. In contrast, the file handle is an internal representation of the data structure, i.e., a representation of the inode data structure that is used internally within the file system 202. The file handle generally consists of a plurality of components including a file ID (inode number) and a flag. The file handle is exchanged between the client 102 and storage system 108 over the network 106 to enable storage system 108 to efficiently retrieve a corresponding file or directory. That is, the file system manager 202 may efficiently access a file or directory by mapping its inode number to a block at storage device 122 using the inode file.

Accordingly, to search for a data container, file system 202 loads a root directory inode 402 from the storage device 122 into memory 114, such that the root inode is represented as an incore inode, and loads any data blocks referenced by the incore root inode. The file system 202 then searches the contents of the root inode data blocks for a directory name, for example, “DIR1”. If the DIR1 directory name is found in those data blocks, the file system 202 uses the corresponding file handle to retrieve the DIR1 directory inode 404 from storage device and loads it (and its data blocks) into memory as an incore inode structure(s). As with the root inode, the directory inode has a plurality of entries; here, however, each entry stores a name of a regular file and its corresponding mapping file handle.

The file system 202 searches the entries of the DIR1 directory inode data blocks to determine whether a regular inode file name, for example, “FOO” exists and, if so, obtains its corresponding file handle (inode number) and loads the regular inode 406 from storage device 122. The file system 202 then returns the file handle for the file name “FOO” to protocol layer (for example, CIFS layer) 204 of the storage operating system 200.

Because the file system manager 202 maintains the inode structure 400, it has access to all the data container metadata and hence is able to efficiently generate the data container signatures described above with respect to FIG. 3B.

Processing System:

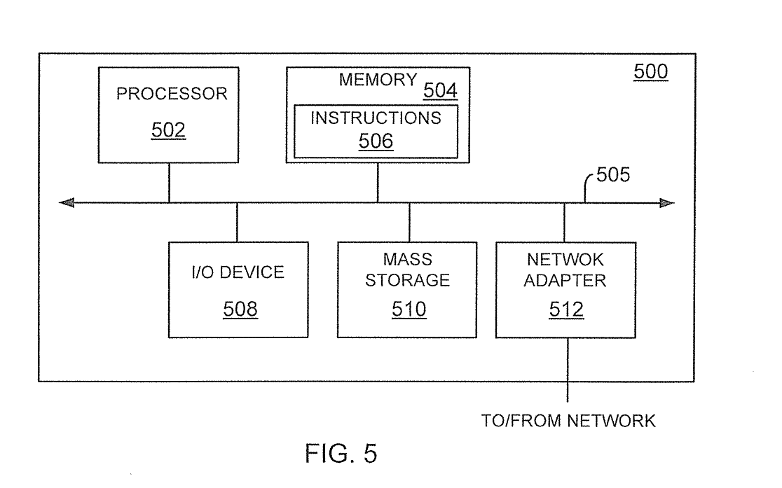

FIG. 5 is a high-level block diagram showing an example of the architecture of a processing system 500 that may be used according to one aspect. The processing system 500 can represent client 102 or storage system 108. Note that certain standard and well-known components which are not germane to the present aspects are not shown in FIG. 5.

The processing system 500 includes one or more processor(s) 502 and memory 504, coupled to a bus system 505. The bus system 505 shown in FIG. 5 is an abstraction that represents any one or more separate physical buses and/or point-to-point connections, connected by appropriate bridges, adapters and/or controllers. The bus system 505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 502 are the central processing units (CPUs) of the processing system 500 and, thus, control its overall operation. In certain aspects, the processors 502 accomplish this by executing software stored in memory 504. A processor 502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 504 represents any form of random access memory (RAM), read-only memory (ROM), flash memory, or the like, or a combination of such devices. Memory 504 includes the main memory of the processing system 500. Instructions 506 implement the process steps described above with respect to FIG. 3B may reside in and execute (by processors 502) from memory 504.

Also connected to the processors 502 through the bus system 505 are one or more internal mass storage devices 510, and a network adapter 512. Internal mass storage devices 510 may be, or may include any conventional medium for storing large volumes of data in a non-volatile manner, such as one or more magnetic or optical based disks. The network adapter 512 provides the processing system 500 with the ability to communicate with remote devices (e.g., storage servers) over a network and may be, for example, an Ethernet adapter, a Fibre Channel adapter, or the like.

The processing system 500 also includes one or more input/output (I/O) devices 508 coupled to the bus system 505. The I/O devices 508 may include, for example, a display device, a keyboard, a mouse, etc.

Cloud Computing:

The system and techniques described above are applicable and useful in the upcoming cloud computing environment. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to the Internet and cloud computing allows shared resources, for example, software and information to be available, on-demand, like a public utility.

Typical cloud computing providers deliver common business applications online which are accessed from another web service or software like a web browser, while the software and data are stored remotely on servers. The cloud computing architecture uses a layered approach for providing application services. A first layer is an application layer that is executed at client computers. In this example, the application allows a client to access storage via a cloud. After the application layer, is a cloud platform and cloud infrastructure, followed by a “server” layer that includes hardware and computer software designed for cloud specific services. Details regarding these layers are not germane to the aspects disclosed herein.

Thus, a method and apparatus for determining data container modification is provided. Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A machine implemented method, comprising:
generating a first data container signature and a second data container signature by a storage operating system based on metadata information of the data container; and
comparing the second data container signature with the first data container signature to determine if the data container has been modified since the first data container signature was generated.

2. The method of claim 1, wherein a processor executing an application out of a memory requests the first data container signature and the second data container signature from the storage operating system.

3. The method of claim 2, wherein the application compares the first data container signature and the second data container signature to determine if the data container has been modified.

4. The method of claim 2, wherein the storage operating system compares the first data signature and the second data signature to determine if the data container was modified and notifies the application that the data container has been modified.

5. The method of claim 1, wherein the metadata information used for generating the first data signature includes a data container size.

6. The method of claim 1, wherein the metadata information used for generating the first data signature includes an inode generation number that is generated when an inode is created for storing the metadata information for the data container.

7. The method of claim 1, wherein the metadata information of the data container used for generating the first data signature includes a virtual volume block number (VVBN) that identifies a block within a logical address space for storing the data container at a physical storage location.

8. The method of claim 1, wherein the data container is a file.

9. A non-transitory, machine readable storage medium storing executable instructions, which when executed by a machine, causes the machine to perform a method, the method comprising
generating a first data container signature and a second data container signature by a storage operating system based on metadata information of the data container; and
comparing the second data container signature with the first data container signature to determine if the data container has been modified since the first data container signature was generated.

10. The storage medium of claim 9, wherein a processor executing an application out of a memory requests the first data container signature and the second data container signature from the storage operating system.

11. The storage medium of claim 10, wherein the application compares the first data container signature and the second data container signature to determine if the data container has been modified.

12. The storage medium of claim 10, wherein the storage operating system compares the first data signature and the second data signature to determine if the data container was modified and notifies the application that the data container has been modified.

13. The storage medium of claim 9, wherein the metadata information used for generating the first data signature includes a data container size.

14. The storage medium of claim 9, wherein the metadata information used for generating the first data signature includes an inode generation number that is generated when an inode is created for storing the metadata information for the data container.

15. The storage medium of claim 9, wherein the metadata information of the data container used for generating the first data signature includes a virtual volume block number (VVBN) that identifies a block within a logical address space for storing the data container at a physical storage location.

16. The storage medium of claim 9, wherein the data container is a file.

17. A system, comprising:
a processor executing instructions out of a memory for:
generating a first data container signature and a second data container signature based on metadata information for the data container, wherein the second data container signature is compared with the first data container signature to determine if the data container has been modified since the first data container signature was generated.

18. The system of claim 17, wherein the metadata information used for generating the first data signature includes a data container size.

19. The system of claim 17, wherein the metadata information of the data container used for generating the first data signature includes a virtual volume block number (VVBN) that identifies a block within a logical address space for storing the data container at a physical storage location.

20. The system of claim 17, wherein the data container is a file.
